(19) United States
(12) Patent Application Publication
(10) Pub. No.: US 2016/0281563 A1
(43) Pub. Date: Sep. 29, 2016

(54) EXHAUST SYSTEM FOR AN INTERNAL COMBUSTION ENGINE OF A MOTOR VEHICLE AND METHOD FOR OPERATING AN EXHAUST SYSTEM

(71) Applicant: AUDI AG, Ingolstadt (DE)

(72) Inventors: VIKTOR SCHIMIK, Erlenbach (DE); ARMIN BURKARDT, Ludwigsburg (DE)

(73) Assignee: AUDI AG, 85045 Ingolstadt (DE)

(21) Appl. No.: 14/777,965

(22) PCT Filed: Mar. 5, 2014
(86) PCT No.: PCT/EP2014/000551

§ 371 Date: Sep. 17, 2015

(30) Foreign Application Priority Data
Mar. 20, 2013 (DE) 10 2013 005 192.4

(51) Int. Cl. F01N 3/08; F01N 3/035; B01D 53/94; F01N 3/20

(52) U.S. Cl. CPC F01N 3/0814; F01N 3/0842; F01N 3/2066; F01N 3/035; B01D 53/9431; F01N 2340/06; F01N 2610/02; B01D 2255/915; B01D 2251/2062

(57) ABSTRACT

An exhaust system for an internal combustion engine of a motor vehicle, includes an SCR catalytic converter for carrying out selective catalytic reduction of pollutants contained in the exhaust gas of the internal combustion engine using a reducing agent, wherein the SCR catalytic converter is arranged downstream of a turbine of an exhaust gas turbocharger, and a feed device for feeding the reducing agent into the exhaust gas at a feed position arranged upstream of the turbine is provided. A nitrogen oxide storage catalytic converter is arranged upstream of the feed position.

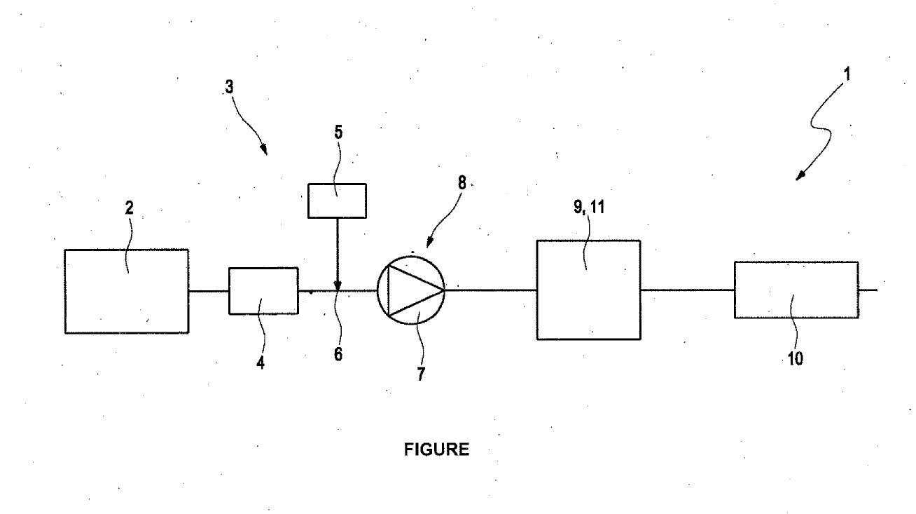

The invention relates to an exhaust gas the system for an internal combustion engine of a motor vehicle with an SCR-catalytic converter for performing a selective catalytic reduction of pollutants contained in the exhaust gas of the internal combustion engine by using a reducing agent, wherein the SCR catalytic converter is arranged upstream of a turbine of an exhaust gas turbocharger and an feed device for feed the reducing agent into the exhaust gas is provided at an introduction position arranged upstream of the turbine. The invention also relates to a method for operating an exhaust gas system.

For lowering the nitric oxide emission of internal combustion engines the exhaust gas system performs a selective catalytic reduction by means of a reducing agent. For this purpose the exhaust gas system includes the SCR-catalytic converter and the feed device for feeding the reducing agent into the exhaust gas. From the state-of-the-art for example the published patent application DE 103 42 003 A1 is known, which discloses a device for preparing a pre-product-solution of a reducing-agent for reducing nitric oxides in the exhaust gas of a internal combustion engine. The device has a controllable heating element and a catalytic coating which comes into contact with the pre product of the reducing agent.

Further as part of the state-of-the-art the published patent application DE 103 57 402 A1 discloses a method for operating an internal combustion engine and a corresponding internal combustion engine. The internal combustion engine has multiple combustion chambers and an emission control system which includes an ammonia-generating catalytic converter which only receives exhaust gas from at least one first combustion chamber. Hereby the following steps are provided: operating the at least one second combustion chamber with a lean combustion-air/fuel mixture; operating the at least first combustion chamber with a less lean combustion-air/fuel mixture and generating an ammonia-generating low-oxygen atmosphere in the exhaust gas of the at least one first combustion chamber. Hereby the air supply to the at least one first combustion chamber is throttled and the low-oxygen conditions in the exhaust gas of the at least one combustion chamber are generated by supplying a reducing agent to the exhaust gas of the at least one first combustion chamber after combustions. From the published patent application WO 2007/069994 A1 an exhaust gas system for an internal combustion engine is known.

It is an object of the invention to propose an exhaust gas system for an internal combustion engine of a motor vehicle which more effectively reduces nitric oxide emission of the internal combustion engine compared to the known state of the art.

According to the invention this is achieved with an exhaust gas system including the features of claim 1. Hereby it is provided to arrange a nitric-oxide-storing catalytic converter upstream of the introduction position. For performing the selective catalytic reduction, the reducing agent is fed into the exhaust gas upstream of the SCR-catalytic converter (SCR: selective catalytic reduction) by means of the feed device. The feed device is thus situated upstream of the SCR-catalytic converter. In order to achieve sufficiently high conversion rates in the SCR-catalytic converter, the fed reducing agent has to be homogenously mixed with the exhaust gas so that no reducing agent is deposited in the exhaust gas system or attaches to walls of the exhaust gas system. In addition when using a urea-water-solution as reducing agent the droplet diameter of the urea-water-mixture has to be as small as possible in order to convert the urea to ammonia as efficiently as possible via thermolysis and/or hydrolysis.

It is known to arrange at least one mixing device in the exhaust gas fluidly between the introduction position and the SCR-catalytic converter. These types of mixers, however, impede the exhaust gas stream and contribute to an increased consumption. In addition they have an adverse effect on the performance build-up and performance achievement of the internal combustion engine. For this reason the turbine exhaust gas turbocharger is used for the efficient mixing of the fed reducing agent and the exhaust gas instead of a mixer. For this purpose the introduction position, at which the reducing agent is fed into the exhaust gas, is arranged upstream of the turbine so that the reducing agent flows through the turbine together with the exhaust gas. The SCR-catalytic converter is provided downstream of the turbine. The aforementioned mixer is thus not required, because the exhaust gas turbocharger or its turbine take over its function.

In addition it is provided that a nitric oxide storage catalytic converter is arranged upstream of the introduction position. This nitric oxide storage catalytic converter serves for example for reducing carbon monoxide and hydrocarbons and also for the intermediate storage of at least a portion of the nitric oxides contained in the exhaust gas. By means of the nitric oxide storage catalytic converter a low light-off-temperature above which an almost complete conversion of the pollutants contained in the exhaust gas occurs, can be reached. In addition heating measures are not required, which lowers the energy consumption of the exhaust gas system and thus improves efficiency of a drive aggregate consisting of the internal combustion engine and the exhaust gas system. For example a nitric oxide storage catalytic converter serves for temporarily storing nitric oxides contained in exhaust gas until the SCR-catalytic converter has reached a defined temperature, m in particular its operating temperature, and is thus available for reducing the nitric oxides.

The introduction of the reducing agent upstream of the turbine of the exhaust gas turbo charger also has the advantage that the reducing agent causes a cooling of the turbine so that an arrangement of the turbine closer to the internal combustion engine is possible than was previously the case.

A refinement of the invention provides that the reducing agent is liquid when fed into the exhaust gas. Thus it is not provided to feed already gaseous reducing agent into the exhaust gas or to vaporize a liquid reducing agent prior to its introduction. Rather the reducing agent is intended to be liquid when first coming into contact with the exhaust gas. In this way the evaporation heat of the reducing agent is fully used for cooling the exhaust gas and thus for cooling the turbine.

A further advantageous embodiment of the invention provides that the distance between the introduction position and the turbine in a direction of flow is selected so that the liquid reducing agent enters the turbine. The turbine usually consists of a stationary arranged guide vane of a guide wheel and an impeller provided impeller vanes. The guide vanes of the guide wheel serve for conducting exhaust gas to the impeller. Correspondingly the exhaust gas first flows through the guide vanes, before flowing through or over the impeller. Correspondingly, the guide vanes are exposed to a higher temperature stress than the impeller or the impeller vanes. For this reason the distance between the introduction position and the turbine is selected so that the reducing agent is at least partially still liquid when entering the turbine. In particular it is provided that the liquid reducing agent contacts the guide vanes, however does not reach the impeller or the impeller vanes. The latter would cause inadmissibly high mechanical stress on the impeller vanes. With such a configuration the guide vanes can be cooled particularly efficiently.

In a particularly preferred embodiment of the invention it is provided that the SCR-catalytic converter is a component of a particle filter. This is in particular realized in that the particle filter is provided with a catalytically active coating so that the particle filter subsequently also operates as SCR-catalytic converter.

Finally it can be provided that a blocking catalytic converter is provided upstream of the SCR-catalytic converter. The blocking catalytic converter for example serves for preventing leakage of reducing agent out of the exhaust gas system into and outer environment of the motor vehicle.

The invention also relates to a method for operating an exhaust gas system in particular according to the above description, wherein the exhaust gas system has an SCR-catalytic converter for performing a selective catalytic reduction of pollutants contained in the exhaust gas of the combustion engine by using a reducing agent, and wherein the SCR-catalytic converter is arranged upstream of a turbine of an exhaust gas turbocharger, and the reducing agent is fed into the exhaust gas by means of a feed device at an introduction position upstream of the turbine. Hereby it is provided that a nitric oxide storage catalytic converter is arranged upstream of the introduction position. The advantages of such a configuration of the exhaust gas system or such a procedure have been described above. The exhaust gas system and the corresponding method can be refined according to the description above to which reference is thus made.

In the following, the invention is explained in more detail by way of exemplary embodiments shown in the drawing without limiting the invention. Hereby it is shown in the

sole FIGURE a schematic representation of a drive device of a motor vehicle with an internal combustion engine and an exhaust gas system.

The FIGURE shows a drive device 1 with an internal combustion engine 2 and an exhaust gas system 3. The exhaust gas produced by the internal combustion engine 2 flows through the exhaust gas system 3, in order to then for example reach an outer environment of the drive device 1 through an tail pipe (not shown) of the exhaust gas system 3. The exhaust gas system 3 has in flow direction a nitric oxide storage catalytic converter 4, an feed device 5 for feed the reducing agent into the exhaust gas at an introduction position 6, a turbine 7 of an exhaust gas turbocharger 8 and a particle filter 9. Optionally a blocking catalytic converter 10 can be provided upstream of the particle filter 9. The particle filter 9 is constructed so that it also operates as SCR-catalytic converter 11. For this purpose the particle filter 9 for example has a corresponding catalytic coating.

The reducing agent, which is fed at the introduction position 6 into the exhaust gas, flows together with the exhaust gas into the turbine 7 of the exhaust gas turbocharger 8. During this flow-through an efficient mixing of the reducing agent with the exhaust gas or a homogenization of the mixture of exhaust gas and reducing agent occurs. Correspondingly nitric oxides can be reduced in the SCR-catalytic converter 11 with high conversion rates. Reducing agent that may still be present in the exhaust gas downstream of the SCR-catalytic converter 11 is temporarily stored and/or converted by means of the correspondingly configured blocking catalytic converter 11.

As a result of the arrangement of the nitric oxide storage catalytic converter 4 upstream of the introduction position 6, a particularly efficient method for operating the exhaust gas system 3 can be realized. For example no reducing agent is fed into the exhaust gas immediately after a start of the internal combustion engine 2. Instead the nitric oxides present in the exhaust gas are temporarily stored by means of the nitric oxide storage catalytic converter 4 at least over a certain period of time. Only when the storage capacity of the nitric oxide storage catalytic converter 4 is exhausted and/or the SCR-catalytic converter 11 has reached its operating temperature, the reducing agent is fed into the exhaust gas so that subsequently nitric oxides can be reduced by means of the SCR catalytic converter 11 by using the reducing agent.

### LIST OF REFERENCE SIGNS

1 drive device
2 internal combustion engine
3 exhaust gas system
4 nitric oxide storage catalytic converter
5 feed device
6 introduction position
7 turbine
8 exhaust gas turbocharger
9 particle filter
10 blocking catalytic converter
11 SCR-catalytic converter

What is claimed is:

1.-6. (canceled)

7. An exhaust gas system for an internal combustion engine of a motor vehicle, comprising:
an SCR-catalytic converter for performing a selective catalytic reduction of pollutants contained in the exhaust gas of the internal combustion engine by using a reducing agent, said SCR-catalytic converter being arranged downstream of a turbine of an exhaust gas turbocharger;
an feed device for introducing the reducing agent into the exhaust gas, said feed device being arranged at an feed position upstream of the turbine; and
a nitric oxide storage catalytic converter arranged upstream of the feed position.

8. The exhaust gas system of claim 1, wherein the reducing agent is liquid when fed into the exhaust gas.

9. The exhaust gas system of claim 8, wherein a distance between the feed position and the turbine in a direction of flow of the exhaust gas is selected so that the liquid reducing agent enters into the turbine.

10. The exhaust gas system of claim 7, further comprising a particle filter, wherein the SCR-catalytic converter is a component of the particle filter.

11. The exhaust gas system of claim 7, further comprising a blocking catalytic converter arranged downstream of the SCR-catalytic converter.
